(19) United States
(12) Patent Application Publication
(10) Pub. No.: US 2025/0189473 A1
(43) Pub. Date: Jun. 12, 2025

(54) Permittivity Measurement Method, Permittivity Measurement System, Permittivity Measurement Program

(71) Applicant: Nippon Telegraph and Telephone Corporation, Tokyo (JP)

(72) Inventors: Masahito Nakamura, Musashino-shi, Tokyo (JP); Takuro Tajima, Musashino-shi, Tokyo (JP); Michiko Seyama, Musashino-shi, Tokyo (JP); Ayumi Ikeda, Musashino-shi, Tokyo (JP)

(21) Appl. No.: 18/837,426

(22) PCT Filed: Feb. 17, 2022
(86) PCT No.: PCT/JP2022/006425

§ 371 Date: Aug. 9, 2024

(51) Int. Cl. G01N 27/02

(52) U.S. Cl. CPC G01N 27/026

(57) ABSTRACT

A method includes the steps of acquiring an admittance of a calibration standard of which a dielectric constant is known, measuring a first reflection coefficient, calculating an open reflection coefficient in an ideal open state of a dielectric spectroscopy sensor on the basis of the first reflection coefficient and the admittance of the calibration standard when the calibration standard is installed on a measurement end surface, calculating a reflection coefficient of another calibration standard other than the first calibration standard on the basis of the open reflection coefficient and an admittance of the another calibration standard, measuring a reflection coefficient of a target object, and calculating a dielectric constant of the target object on the basis of the first reflection coefficient, the reflection coefficient of the another calibration standard, the reflection coefficient of the target object, the admittance of the first calibration standard, and the admittance of the another calibration standard.

### TECHNICAL FIELD

The present invention relates to a dielectric constant measurement method, a dielectric constant measurement system, and a dielectric constant measurement program.

### BACKGROUND ART

A component concentration test such as that for a blood glucose level requires sampling of blood, which is a heavy burden on a patient. Therefore, a non-invasive component concentration measurement device that does not sample blood has been put into practical use.

Non Patent Literature 1 discloses a technique in which a device having a high Q value, such as an antenna or a resonator, is brought into contact with a measurement sample to measure frequency characteristics around a resonance frequency, and a component concentration is estimated on the basis of a shift amount of the resonance frequency. Patent literature 1 discloses a technique in which a complex dielectric constant is calculated according to dielectric spectroscopy and a component concentration is measured.

Non Patent Literatures 2 and 3 and Patent Literature 2 disclose a technique in which a dielectric constant of a measurement sample is measured by bringing a measurement sample into contact with an end surface of a coaxial probe.

### CITATION LIST

### Patent Literature

Patent Literature 1: JP 2013-32933 A
Patent Literature 2: JP 6771372 B2

### Non Patent Literature

Non Patent Literature 1: M. Hofmann, G. Fischer, R. Weigel, and D. Kissinger, “Microwave-Based Noninvasive Concentration Measurements for Biomedical Applications”, IEEE Trans. Microwave Theory and Techniques, Vol. 61, No. 5, pp. 2195-2203, 2013
Non Patent Literature 2: J P. Grant, R N. Clarke, G T. SYymm and N M. Spyrou, “A critical study of the open-ended coaxial line sensor technique for RF and microwave complexpermittivity measurements”, J. Phys. E: Sci. Instrum, Vol. 22, pp. 757-770, 1989
Non Patent Literature 3: T. P. Marsland, and S. Evans “Dielectric measurements with an open-ended coaxial probe”, IEE Proceedings, Vol. 134, No. 4, 1987

### SUMMARY OF INVENTION

### Technical Problem

Measurement of a dielectric constant using a coaxial probe depends on an S11 parameter of a calibration standard measured in advance, and generally, the S11 parameters such as those for air, a metal plate for probe short circuiting, or water needs to be measured in advance.

However, when an S11 parameter of the calibration standard is measured by using a metal plate, it is necessary to accurately bring a surface of a coaxial probe into contact with the metal plate. Thus, an operator needs to have an advanced technical skill. Alternatively, an operator needs to use a measurement jig at the time of measurement.

When an S11 parameter of the calibration standard is measured by using a liquid sample, it is necessary to accurately measure the temperature of the liquid by installing a temperature sensor or the like, and there is a problem that a size of a measurement device increases.

The present invention has been made in view of the above circumstances, and an object of the present invention is to provide a dielectric constant measurement method, a dielectric constant measurement system, and a dielectric constant measurement program capable of easily measuring a dielectric constant of a target object.

### Solution to Problem

According to an aspect of the present invention, there is provided a dielectric constant measurement method of measuring a dielectric constant of a target object by using a dielectric spectroscopy sensor, the dielectric constant measurement method including a step of acquiring an admittance of a first calibration standard of which a dielectric constant is known; a step of measuring a first reflection coefficient of the first calibration standard; a step of calculating an open reflection coefficient in an ideal open state of the dielectric spectroscopy sensor on the basis of the first reflection coefficient and the admittance of the first calibration standard when the first calibration standard is installed on a measurement end surface of the dielectric spectroscopy sensor; a step of calculating a reflection coefficient of another calibration standard other than the first calibration standard on the basis of the open reflection coefficient and an admittance of the another calibration standard; a step of measuring a reflection coefficient of the target object; and a step of calculating the dielectric constant of the target object on the basis of the first reflection coefficient, the reflection coefficient of the another calibration standard, the reflection coefficient of the target object, the admittance of the first calibration standard, and the admittance of the another calibration standard.

According to another aspect of the present invention, there is provided a dielectric constant measurement method of measuring a dielectric constant of a target object by using a dielectric spectroscopy sensor, the dielectric constant measurement method including a step of acquiring an admittance of a first calibration standard of which a dielectric constant is known; a step of measuring a first reflection coefficient of the first calibration standard; a step of generating a first admittance calculation expression for calculating an admittance from a dielectric constant on the basis of the admittance of the first calibration standard and the dielectric constant; a step of generating a second admittance calculation expression for calculating an admittance of the target object on the basis of the first reflection coefficient and an open reflection coefficient in an ideal open state of the dielectric spectroscopy sensor; and a step of calculating the dielectric constant of the target object on the basis of a fact that an admittance calculated by using the first admittance calculation expression is equal to an admittance calculated by using the second admittance calculation expression.

According to still another aspect of the present invention, there is provided a dielectric constant measurement system including a dielectric spectroscopy sensor having a coaxial probe and a measurement surface formed at the coaxial probe; and a measurement device connected to the dielectric spectroscopy sensor via a transmission line having the same characteristic impedance as a characteristic impedance of the coaxial probe, in which the measurement device includes a measurement unit that applies a predetermined voltage to the dielectric spectroscopy sensor and measures a reflection coefficient of a measurement object on the basis of a reflection signal of the predetermined voltage, and a calculation unit that calculates an open reflection coefficient in an ideal open state of the dielectric spectroscopy sensor on the basis of a first reflection coefficient of a first calibration standard and an admittance of the first calibration standard when the first calibration standard is installed on a measurement end surface of the dielectric spectroscopy sensor, calculates a reflection coefficient of another calibration standard other than the first calibration standard on the basis of the open reflection coefficient and an admittance of the another calibration standard, and calculates a dielectric constant of a target object on the basis of the first reflection coefficient, the reflection coefficient of the another calibration standard, a reflection coefficient of the target object measured by the measurement unit, the admittance of the first calibration standard, and the admittance of the another calibration standard.

According to still another aspect of the present invention, there is provided a dielectric constant measurement program for causing a computer to execute the dielectric constant measurement method according to any one of claims 1 to 5.

### Advantageous Effects of Invention

According to the present invention, it is possible to easily measure a dielectric constant of a target object.

### BRIEF DESCRIPTION OF DRAWINGS

FIG. 1 is a block diagram illustrating a configuration of a dielectric constant measurement system according to an embodiment.

FIG. 2 is an explanatory diagram illustrating a state in which a dielectric constant of a target object is measured by the dielectric constant measurement system.

FIG. 3A is an explanatory diagram schematically illustrating calibration of a transmission line and a dielectric spectroscopy sensor.

FIG. 3B is an explanatory diagram illustrating the transmission line, the dielectric spectroscopy sensor, and a state in which a measurement object is installed on a measurement end surface of the dielectric spectroscopy sensor.

FIG. 4 is an equivalent circuit diagram of the transmission line and the dielectric spectroscopy sensor.

FIG. 5A is an equivalent circuit diagram when the measurement end surface of the dielectric spectroscopy sensor is in an ideal open state.

FIG. 5B is an equivalent circuit diagram when an inner conductor and an outer conductor are short-circuited at the measurement end surface of the dielectric spectroscopy sensor.

FIG. 6 is a flowchart illustrating a processing procedure of the dielectric constant measurement system according to a first embodiment.

FIG. 7 is an explanatory diagram illustrating a state in which two calibration standards are measured by the dielectric constant measurement system.

FIG. 8 is a graph illustrating an S11 parameter calculated according to the present embodiment and an amplitude of S11 obtained through actual measurement.

FIG. 9 is a graph illustrating an S11 parameter calculated according to the present embodiment and a phase of S11 obtained through actual measurement.

FIG. 10 is a graph illustrating a dielectric constant calculated according to the present embodiment and a dielectric constant calculated according to a conventional method.

FIG. 11 is a graph illustrating an error between the dielectric constant calculated according to the present embodiment and the dielectric constant calculated according to the conventional method.

FIG. 12 is a flowchart illustrating a processing procedure of a dielectric constant measurement system according to a second embodiment.

FIG. 13 is a block diagram illustrating a hardware configuration of the present embodiment.

### DESCRIPTION OF EMBODIMENTS

### First Embodiment

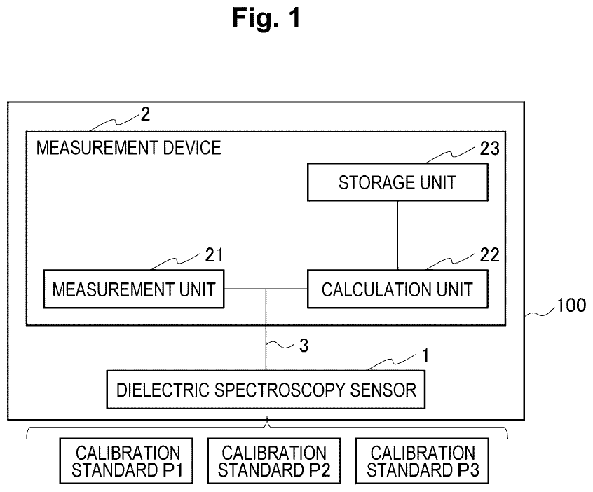

Hereinafter, a first embodiment will be described with reference to the drawings. FIG. 1 is a block diagram illustrating a configuration of a dielectric constant measurement system according to the first embodiment.

As illustrated in FIG. 1, a dielectric constant measurement system 100 includes a dielectric spectroscopy sensor 1, a measurement device 2, and a transmission line 3 electrically connecting the dielectric spectroscopy sensor 1 and the measurement device 2.

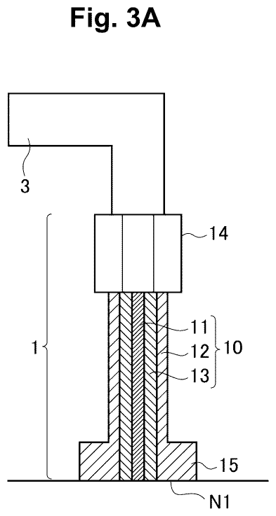

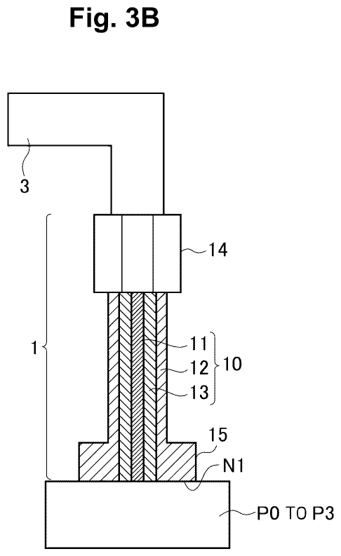

FIG. 3A is an explanatory diagram schematically illustrating configurations of the dielectric spectroscopy sensor 1 and the transmission line 3. As illustrated in FIG. 3A, the dielectric spectroscopy sensor 1 includes a coaxial probe 10, a connector 14, and a fringe 15. In FIG. 3A, the coaxial probe 10 and the fringe 15 are shown in a cross-sectional view.

The coaxial probe 10 includes an inner conductor 11 and an outer conductor 12 formed on an outer circumference of the inner conductor 11. An insulator 13 is provided between the inner conductor 11 and the outer conductor 12.

The connector 14 connects one end of the coaxial probe 10 to one end of the transmission line 3. The other end of the transmission line 3 is connected to the measurement device 2 illustrated in FIG. 1. The characteristic impedance of the transmission line 3 is set to be equal to the characteristic impedance of the coaxial probe 10. Note that “the characteristic impedances are equal” means that not only both characteristic impedances completely match but also there is a slight difference therebetween.

The fringe 15 is connected to the other end of the coaxial probe 10. The fringe 15 has a disk shape. An end surface of the fringe 15 is a measurement end surface N1 with which any measurement object is brought into contact. The measurement object includes a gas such as air, a liquid such as water, and a solid such as a metal. The measurement object includes a calibration standard that will be described later and a target object to be measured for a dielectric constant.

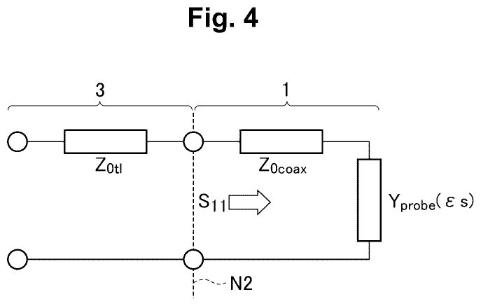

FIG. 4 is an explanatory diagram illustrating an equivalent circuit of the dielectric spectroscopy sensor 1 and the transmission line 3. “Z0t1” illustrated in FIG. 4 indicates the characteristic impedance of the transmission line 3, and “Z0coax” indicates the characteristic impedance of the coaxial probe 10. “Yprobe (ε)” indicates a normalized admittance of a measurement object installed on the measurement end surface N1. Since the characteristic impedance of the transmission line 3 is equal to the characteristic impedance of the coaxial probe 10 as described above, Z0t1=Z0coax is satisfied.

Returning to FIG. 1, the measurement device 2 includes a measurement unit 21, a calculation unit 22, and a storage unit 23.

The measurement unit 21 outputs a predetermined voltage to the dielectric spectroscopy sensor 1. The measurement unit 21 receives a reflection signal output from the dielectric spectroscopy sensor 1. That is, when a predetermined voltage is applied between the inner conductor 11 and the outer conductor 12 in a state in which the measurement object is installed on the measurement end surface N1 of the dielectric spectroscopy sensor 1, a reflection signal is generated at the measurement end surface N1. The measurement unit 21 receives the reflection signal generated at the measurement end surface N1. The measurement unit 21 measures a reflection coefficient of the measurement object on the basis of the received reflection signal.

That is, the measurement unit 21 applies a predetermined voltage to the dielectric spectroscopy sensor 1, and measures a reflection coefficient of the measurement object on the basis of the reflection signal. Hereinafter, the “reflection coefficient” may be referred to as an “S11 parameter”.

The storage unit 23 stores various calculation expressions used for calculation executed by the calculation unit 22. Specifically, the storage unit 23 stores an admittance calculation expression for calculating an admittance of one measurement object on the basis of a dielectric constant of one measurement object. The admittance calculation expression is, for example, Expression (9) that will be described later.

The storage unit 23 stores a reflection coefficient calculation expression indicating a relationship between a first reflection coefficient (“S11_load” that will be described later), an admittance of the measurement object, and an open reflection coefficient in an ideal open state of the dielectric spectroscopy sensor 1 when the measurement object is installed on the measurement end surface. The reflection coefficient calculation expression is, for example, Expression (17) that will be described later, and details thereof will be described later.

The calculation unit 22 calculates a dielectric constant of the measurement object installed on the measurement end surface N1 by executing calculation that will be described later on the basis of the reflection coefficient, the admittance, and the dielectric constant of each measurement object measured by the measurement unit 21. Hereinafter, a measurement object to be measured for the dielectric constant will be referred to as a “target object”.

Specifically, the calculation unit 22 performs calculation of calculating an open reflection coefficient according to the reflection coefficient calculation expression on the basis of an admittance of a calibration standard P1 of which a dielectric constant ε is known and a first reflection coefficient of the calibration standard P1 measured by the measurement unit 21, and calculation of calculating a reflection coefficient of another calibration standard according to the reflection coefficient calculation expression on the basis of the open reflection coefficient and an admittance of another calibration standard other than the calibration standard P1, and calculates a dielectric constant of the target object on the basis of a reflection coefficient of the target object, the first reflection coefficient, the reflection coefficient of another calibration standard, the admittance of the first calibration standard, and the admittance of another calibration standard.

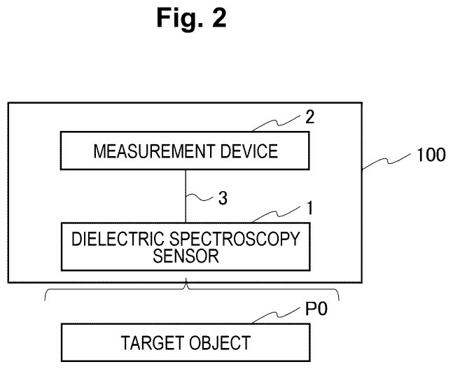

Next, a procedure of calculating a dielectric constant of a target object by using the dielectric spectroscopy sensor 1 will be described. When a dielectric constant of a target object is calculated by using the dielectric spectroscopy sensor 1, a plurality of calibration standards of which dielectric constants are known are prepared. As an example, calibration standards P1 to P3 are prepared as illustrated in FIG. 1, and reflection coefficients ρ1 to ρ3 of the respective calibration standards P1 to P3 are measured by using the dielectric spectroscopy sensor 1. As illustrated in FIG. 2, a target object P0 is installed on the measurement end surface (N1 illustrated in FIG. 3A) of the dielectric spectroscopy sensor 1, and a reflection coefficient om of the target object P0 is measured. The measurement device 2 calculates a dielectric constant εs of the target object P0 on the basis of the dielectric constants ε1 to ε3 and the reflection coefficients ρ1 to ρ3 of the respective calibration standards P1 to P3 and the reflection coefficient om of the target object P0. This will be described below in more detail.

FIG. 3B is an explanatory diagram illustrating a state in which a measurement object such as the calibration standard P1 is installed on the measurement end surface N1 of the dielectric spectroscopy sensor 1. The measurement unit 21 applies a voltage with a predetermined frequency between the inner conductor 11 and the outer conductor 12 in a state in which the calibration standard P1 is installed on the measurement end surface N1. The measurement unit 21 receives a reflected wave generated at the measurement end surface N1, and calculates the reflection coefficient ρ1 of the calibration standard P1 on the basis of the reflected wave.

By performing the above operation on the other two calibration standards P2 and P3 and the target object P0, the reflection coefficients ρ1 to ρ3 of the respective calibration standards P1 to P3 and the reflection coefficient μm of the target object P0 are acquired.

By using the reflection coefficients ρ1 to ρ3 and μm, the calculation unit 22 calculates the dielectric constant εs of the target object P0 according to the coaxial probe method by using the following calculation expression.

When admittances of the calibration standards P1 to P3 and the target object P0 are y1, y2, y3, and ym, respectively, the following Expressions (1) and (2) are established.

$$\begin{matrix}[ Math . 1 ] & \\ \frac{( {ρ}_{m} - {ρ}_{1} ) ( {ρ}_{3} - {ρ}_{2} )}{( {ρ}_{m} - {ρ}_{2} ) ( {ρ}_{1} - {ρ}_{3} )} = \frac{( {y}_{m} - {y}_{1} ) ( {y}_{3} - {y}_{2} )}{( {y}_{m} - {y}_{2} ) ( {y}_{1} - {y}_{3} )} & ( 1 )\end{matrix}$$

$$\begin{matrix}[ Math . 2 ] & \\ {y}_{i} = {ε}_{i} + \frac{{G}_{0}}{j ω {C}_{0}} {ε}_{i}^{5 / 2} ( i = 1 , 2 , 3 , m ) & ( 2 )\end{matrix}$$

In Expression (1), the respective reflection coefficients “ρ1 to ρ3, and ρm” are measured values. “y1, y2, y3, and ym” are linear mapping of the admittances, and are indicated by the same reference signs as the admittances y1, y2, y3, and ym. In Expression (2), “GO” is a conductance of the coaxial probe 10 in vacuum, and “CO” is a capacitance of the coaxial probe 10 in vacuum.

Here, a case where the calibration standard P3 among the three calibration standards P1 to P3 is a metal is considered. Hereinafter, the admittance “y3” of the calibration standard P3 is denoted by “ys”, and the reflection coefficient “ρ3” is denoted by “ρs”. Since the admittance ys is ∞, the above Expressions (1) and (2) can be modified as the following Expressions (3), (4), and (5).

$$\begin{matrix}[ Math . 3 ] & \\ {y}_{m} = - ( \frac{{Δ}_{m \_ 1} {Δ}_{s \_ 2}}{{Δ}_{m \_ s} {Δ}_{2 \_ 1}} {y}_{2} + \frac{{Δ}_{m \_ 2} {Δ}_{1 \_ s}}{{Δ}_{m \_ s} {Δ}_{2 \_ 1}} {y}_{1} ) & ( 3 )\end{matrix}$$

$$\begin{matrix}[ Math . 4 ] & \\ {y}_{i} = \{ \begin{matrix}{ε}_{i} & ( i = 1 , 2 , m ) \\ ∞ & ( i = s )\end{matrix} & ( 4 )\end{matrix}$$

$$\begin{matrix}[ Math . 5 ] & \\ {Δ}_{i \_ j} = {ρ}_{i} - {ρ}_{j} & ( 5 )\end{matrix}$$

By substituting Expression (4) into Expression (3), the following Expression (6) is obtained.

$$\begin{matrix}[ Math . 6 ] & \\ {ε}_{m} = - ( \frac{{Δ}_{m \_ 1} {Δ}_{s \_ 2}}{{Δ}_{m \_ s} {Δ}_{2 \_ 1}} {ε}_{2} + \frac{{Δ}_{m \_ 2} {Δ}_{1 \_ s}}{{Δ}_{m \_ s} {Δ}_{2 \_ 1}} {ε}_{1} ) & ( 6 )\end{matrix}$$

That is, the dielectric constant as of the target object P0 can be calculated by measuring the reflection coefficients ρ1, ρ2, ρs, and ρm of the three calibration standards P1 to P3 and the target object P0 by using the dielectric spectroscopy sensor 1, calculating the admittances y1, y2, ys, and ym, and substituting the admittances y1, y2, ys, and ym into the above Expression (6).

However, when the reflection coefficients ρ1, ρ2, and ρs of the three calibration standards P1, P2, and P3 are measured, it is necessary to accurately bring the calibration standard such as a metal into contact with the measurement end surface N1 as illustrated in FIG. 3B. Thus, an operator needs to have an advanced technical skill. Alternatively, a measurement jig is required. When the calibration standard is a liquid, it is necessary to accurately measure the temperature of the liquid by using a temperature sensor in combination.

In the present embodiment, the dielectric constant εs of the target object P0 is calculated by using one calibration standard P1. By using air as the calibration standard P1, it is possible to reduce trouble such as accurately bringing the calibration standard P1 into contact with the measurement end surface N1. Hereinafter, a method of calculating the dielectric constant εs of the target object P0 by using one calibration standard P1 (first calibration standard) will be described.

In the equivalent circuit illustrated in FIG. 4 described above, the characteristic impedance Z0t1 in a case where the transmission line 3 is a microstrip line can be expressed by the following Expression (7). The characteristic impedance Z0t1 in a case where the transmission line 3 is a coaxial cable can be expressed by the following Expression (8).

$$\begin{matrix}[ Math . 7 ] & \\ {Z}_{0 tl} = \frac{1}{\sqrt{{ε}_{sub}}} \cdot 60 log [ \frac{8 h}{W} - 0.358 + \frac{1}{\frac{0.931 h}{W} + 0.736} ] & ( 7 )\end{matrix}$$

$$\begin{matrix}[ Math . 8 ] & \\ {Z}_{0 tl} = \frac{138.1}{\sqrt{{ε}_{c}}} log \frac{D}{d} & ( 8 )\end{matrix}$$

In Expression (7), “εsub” is a substrate dielectric constant of the microstrip line, “h” is a thickness of the substrate, and “W” is a line width. In Expression (8), “εc” is a dielectric constant of the inner dielectric of the coaxial cable forming the transmission line 3, “D” is an inner diameter of the outer conductor of the coaxial cable, and “d” is an outer diameter of the inner conductor of the coaxial cable.

The characteristic impedances Z0t1 and Z0coax illustrated in FIG. 4 are constant values because the values are determined when the dielectric spectroscopy sensor 1 is manufactured. As described above, the characteristic impedances Z0t1 and Z0coax have the same numerical value, and are set to be, for example, 50 Ω, 75 Ω, or 100 Ω.

Assuming that a normalized admittance in the measurement end surface N1 is “Yprobe(εs)”, the normalized admittance Yprobe(εs) is expressed by the following Expression (9). That is, Expression (9) is an admittance calculation expression.

$$\begin{matrix}[ Math . 9 ] & \\ Yprobe ( {ε}_{s} ) = \frac{{jk}_{0} {ε}_{s}}{\sqrt{{ε}_{c}} log ( \frac{b}{a} )} {\int }_{0}^{∞} \frac{{[ {J}_{0} ( ζ a ) - {J}_{0} ( ζ b ) ]}^{2}}{γ ( {ε}_{s} ) ζ} d ζ & ( 9 )\end{matrix}$$

In Expression (9), “εc” is a dielectric constant of the insulator 13 provided in the coaxial probe 10, “k0” is a wave number at a measurement frequency, “εs” is a dielectric constant of the target object P0, “γ” is a propagation constant in the target object P0, “J0(x)” is a 0-order Bessel function, “a” is a radius of the outer diameter of the inner conductor 11 of the coaxial probe 10, and “b” is a radius of the inner diameter of the outer conductor 12. In Expression (9), “ζ” represents a weighting factor of the Hankel transform.

The calculation program of Expression (9) described above is stored in the storage unit 23 illustrated in FIG. 1. That is, the storage unit 23 stores Expression (9) that is an admittance calculation expression for calculating an admittance of one measurement object on the basis of a dielectric constant of one measurement object.

Although Expression (9) is an expression in a case where electromagnetic waves propagating dielectric through the spectroscopy sensor 1 is only in the TEM mode, a normalized admittance may be calculated in consideration of any higher-order mode.

The normalized admittance Yprobe (as) illustrated in FIG. 4 varies depending on the dielectric constant as of the target object P0. Assuming that a connection portion between the transmission line 3 and the dielectric spectroscopy sensor 1 illustrated in FIG. 4 is a calibration end surface N2, an S11 parameter indicating a reflection coefficient is expressed by the following Expression (10).

$$\begin{matrix}[ Math . 10 ] & \\ {S}_{11} = \frac{{Z}_{sens} - {Z}_{0 coax}}{{Z}_{sens} + {Z}_{0 coax}} & ( 10 )\end{matrix}$$

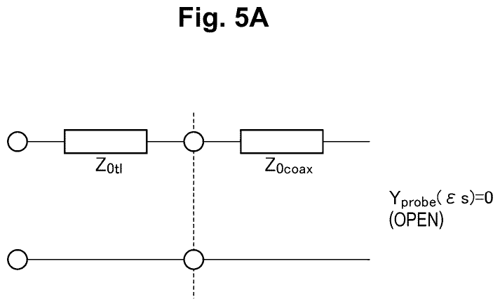

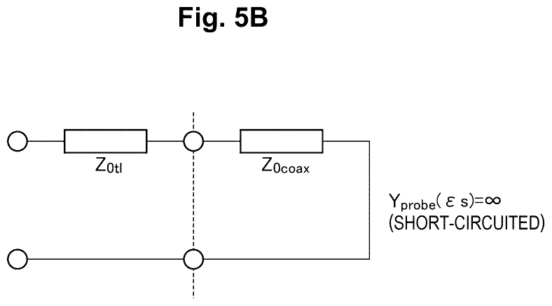

In Expression (10), “Zsens” is an impedance of the dielectric spectroscopy sensor 1 viewed from the calibration end surface (N2 in FIG. 4). Here, an ideal open state in which electromagnetic waves are completely reflected from the measurement end surface N1 without being affected by a radiation from the measurement end surface N1 or a leakage electric field will be considered. In the ideal open state, the equivalent circuit has Yprobe(εs)=0 as illustrated in FIG. 5A.

In the ideal open state, it is difficult for the dielectric spectroscopy sensor 1 to measure a reflection coefficient (S11 parameter). However, it can be calculated by adopting the following Expressions (11) and (12). That is, assuming that the measurement end surface N1 is in an ideal open state, the impedance Zsens of the dielectric spectroscopy sensor 1 can be expressed by the following Expression (11).

$$\begin{matrix}[ Math . 11 ] & \\ {Z}_{sens} = {Z}_{0 coax} coth ( j β l ) & ( 11 )\end{matrix}$$

In Expression (11), “coth” is a hyperbolic cotangent (an inverse of “tanh hyperbolic tangent”). “j” of “jβl” indicates an imaginary unit, “β” indicates a propagation constant of the coaxial probe 10, and “l” indicates a line length of the coaxial probe 10.

The above Expression (10) may be modified into the following Expression (12) by using Expression (11).

$$\begin{matrix}[ Math . 12 ] & \\ {S}_{11 Idealopen} = \frac{( {Z}_{0 coax} - {Z}_{0 tl} ) {e}^{j β l} + ( {Z}_{0 coax} + {Z}_{0 tl} ) {e}^{- j β l}}{( {Z}_{0 coax} + {Z}_{0 tl} ) {e}^{j β l} + ( {Z}_{0 coax} - {Z}_{0 tl} ) {e}^{- j β l}} & ( 12 )\end{matrix}$$

Therefore, the S11 parameter “S11_Idealopen” in an ideal open state can be calculated by using Expression (12).

Next, a state in which the inner conductor 11 and the outer conductor 12 of the coaxial probe 10 are short-circuited without being affected by radiation from the measurement end surface N1 of the dielectric spectroscopy sensor 1 or a leakage electric field will be considered. In the short-circuited state, the equivalent circuit has Yprobe(εs)=∞ as illustrated in FIG. 5B. The short-circuited state is considered to be equivalent to a case where a metal is selected as a calibration standard and the measurement end surface N1 is short-circuited. In this case, the impedance of the dielectric spectroscopy sensor 1 is expressed by the following Expression (13).

$$\begin{matrix}[ Math . 13 ] & \\ {Z}_{sens} = {Z}_{0 coax} tanh ( j β l ) & ( 13 )\end{matrix}$$

The above Expression (13) may be modified into the following Expression (14).

$$\begin{matrix}[ Math . 14 ] & \\ {S}_{11 Short} = \frac{( {Z}_{0 coax} - {Z}_{0 tl} ) {e}^{j β l} - ( {Z}_{0 coax} + {Z}_{0 tl} ) {e}^{- j β l}}{( {Z}_{0 coax} + {Z}_{0 tl} ) {e}^{j β l} - ( {Z}_{0 coax} - {Z}_{0 tl} ) {e}^{- j β l}} & ( 14 )\end{matrix}$$

As described above, the characteristic impedance of the transmission line 3 and the characteristic impedance of the coaxial probe 10 are set to be the same. That is, in FIG. 4, it is assumed that Z0t1=Z0coax. Therefore, Expressions (12) and (14) become the following Expressions (15) and (16), respectively.

$$\begin{matrix}[ Math . 15 ] & \\ {S}_{11 Idealopen} = \frac{{e}^{- j β l}}{{e}^{j β l}} & ( 15 )\end{matrix}$$

$$\begin{matrix}[ Math . 16 ] & \\ {S}_{11 Short} = - \frac{{e}^{- j β l}}{{e}^{j β l}} = - {S}_{11 Idealopen} & ( 16 )\end{matrix}$$

Assuming that any load (a load of which a normalized admittance is Yprobe) is connected to the measurement end surface N1 of the dielectric spectroscopy sensor 1, the above-described Expression (10) may be modified into the following Expression (17). Expression (17) is a reflection coefficient calculation expression. A calculation program for Expression (17) is stored in the storage unit 23. That is, the storage unit 23 stores the above Expression (17) (reflection coefficient calculation expression) indicating a relationship between the first reflection coefficient (S11_load), the admittance of the measurement object, and the open reflection coefficient in the ideal open state of the dielectric spectroscopy sensor 1 when the measurement object is installed on the measurement end surface.

$$\begin{matrix}[ Math . 17 ] & \\ {S}_{11 load} = \frac{{e}^{- j β l}}{{e}^{j β l}} \cdot \frac{\frac{1}{{Y}_{probe}} - {Z}_{0 coax}}{\frac{1}{{Y}_{probe}} + {Z}_{0 coax}} = {S}_{11 Idealopen} \cdot \frac{1 - {Y}_{probe}}{1 + {Y}_{probe}} & ( 17 )\end{matrix}$$

From the relationships of Expressions (15), (16), and (17) described above, an S11 parameter of any calibration standard can be calculated by using the S11 parameter in the ideal open state and the normalized admittance Yprobe(εs) of the measurement end surface N1. Note that the calculation expressions shown in the above Expressions (9) and (15) to (17) are stored in the storage unit 23 illustrated in FIG. 1.

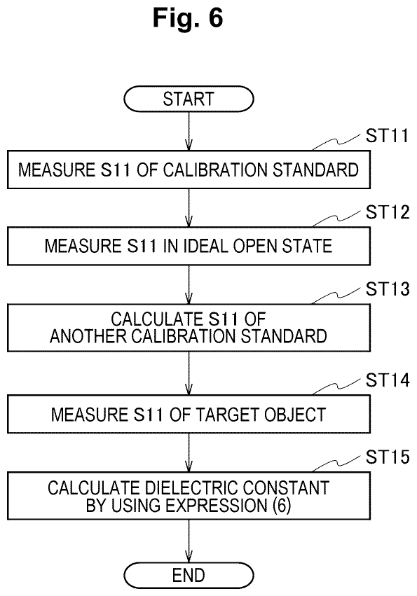

In the present embodiment, on the basis of the above relationship, the dielectric constant εs of the target object P0 is measured through a processing procedure illustrated in FIG. 6. Hereinafter, a procedure of calculating the dielectric constant εs of the target object P0 will be described.

FIG. 6 is a flowchart illustrating a processing procedure of the dielectric constant measurement method according to the first embodiment.

First, a normalized admittance of the calibration standard P1 is acquired. If an admittance of the calibration standard is known, the normalized admittance is obtained on the basis of this admittance. Alternatively, the normalized admittance is calculated by substituting the dielectric constant of the calibration standard P1 into the admittance calculation expression shown in the above Expression (9). That is, the admittance of the first calibration standard of which a dielectric constant is known is acquired.

In step ST11, the measurement unit 21 of the measurement device 2 calculates an S11 parameter (S11_load; first reflection coefficient) of the calibration standard P1. That is, the first reflection coefficient of the first calibration standard is measured. The calibration standard P1 is, for example, air. Since the air does not require a measurement jig and a temperature sensor and has high reproducibility, it does not require much trouble of measuring the S11 parameter. Note that the calibration standard P1 is not limited to air, and other substances may be used.

In step ST12, the calculation unit 22 calculates the normalized admittance Yprobe(εs) in the ideal open state according to above Expression (9). The calculation unit 22 substitutes the calculated normalized admittance Yprobe(εs) into the above Expression (17), and further substitutes “S11_load” measured in step ST11 to calculate the S11 parameter (S11_Idealopen) in the ideal open state.

That is, the normalized admittance of the calibration standard P1 and the first reflection coefficient are substituted into the reflection coefficient calculation expression (17) indicating a relationship between the first reflection coefficient (S11_load), the normalized admittance of the calibration standard P1, and the open reflection coefficient (S11_Idealopen) in the ideal open state of the dielectric spectroscopy sensor 1 when the calibration standard P1 (first calibration standard) is installed on the measurement end surface N1 of the dielectric spectroscopy sensor 1 to calculate the open reflection coefficient (S11 parameter).

In a case where a metal is used as the calibration standard P1, the above Expression (16) may be used instead of Expression (17). That is, when the calibration standard is a metal (short circuit), Expression (16) is established, and thus, even if the normalized admittance Yprobe(εs) is not calculated, S11_Idealopen can be calculated by multiplying S11_short by “−1”.

In step ST13, the calculation unit 22 uses S11_Idealopen calculated in step ST12 and Expressions (16) and (17) stored in the storage unit 23 to calculate S11 parameters when other calibration standards, that is, the calibration standards P2 and P3 are installed on the measurement end surface N1. That is, the open reflection coefficient (S11_Idealopen) and the normalized admittances of the calibration standards P2 and P3 other than the calibration standard P1 are substituted into the reflection coefficient calculation expression to calculate reflection coefficients other calibration standards P2 and P3.

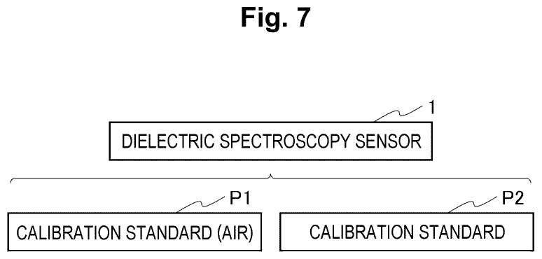

Therefore, the respective S11 parameters can be acquired without measuring the S11 parameters for the calibration standards P2 and P3. Note that a calibration standard that s easy in measurement may be adopted, and an S11 parameter for this calibration standard may be measured. In this case, as illustrated in FIG. 7, S11 parameters are measured for the two calibration standards P1 and P2.

When two or more calibration standards are used, a substance having high measurement reproducibility is used in a measurement environment in addition to air. For example, a liquid sample such as water, methanol, or a liquid metal may be used. In an environment where the temperature is unstable, in a case where it is not desired to use a sample having high temperature dependency of the dielectric constant such as a liquid as a calibration standard, a metal plate and a conductor such as a liquid metal may be used.

In step ST14, an S11 parameter of the target object P0 is measured. That is, a reflection coefficient of the target object P0 is measured. As a result, the S11 parameter of the calibration standard P1 acquired through the measurement, the S11 parameters of the calibration standards P2 and P3 calculated through the calculation, and the S11 parameter of the target object P0 acquired through the measurement are obtained.

In step ST15, the calculation unit 22 calculates the dielectric constant εs of the target object P0 according to the above Expression (6) on the basis of the S11 parameters (reflection coefficients ρ1, ρ2, ρ3, and ρm) of the calibration standards P1, P2, and P3, and the target object P0, and the admittances y1, y2, y3, and ym of the calibration standards P1, P2, and P3, and the target object P0.

That is, the dielectric constant of the target object P0 is calculated on the basis of the first reflection coefficient, the reflection coefficients of the other calibration standards P2 and P3, the reflection coefficient of the target object P0, the normalized admittance of the calibration standard P1, and the normalized admittances of the other calibration standards P2 and P3.

As described above, an S11 parameter of one calibration standard P1, for example, an S11 parameter of water is measured, and an S11 parameter of the target object P0 can be calculated without actually measuring S11 parameters of the calibration standards P2 and P3, and furthermore, the dielectric constant εs of the target object P0 can be calculated.

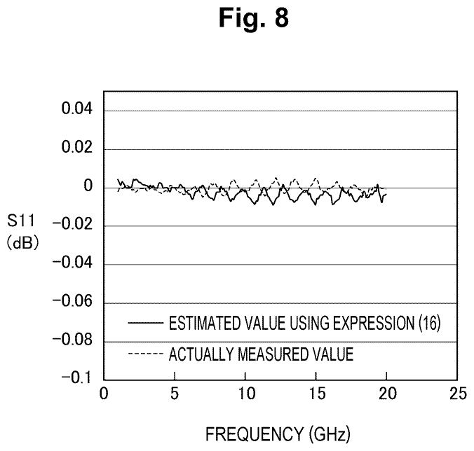

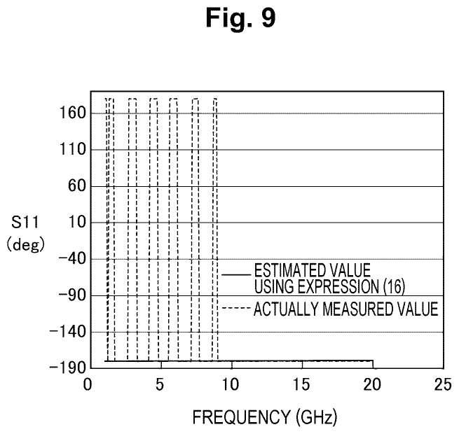

FIGS. 8 and 9 are graphs illustrating results of estimating S11 parameters in a short-circuited state according to the present embodiment for the coaxial probe 10 in which the outer diameter of the inner conductor 11 provided in the coaxial probe 10 is 3.0 mm, the inner diameter of the outer conductor 12 is 4.8 mm, the relative dielectric constant of the insulator 13 is 3.3, and the probe length is 47.1 mm.

FIG. 8 is a graph illustrating an actually measured value of an amplitude of the S11 parameter and an amplitude calculated by using the above Expression (16) when the measurement end surface N1 is in the short-circuited state. A curve indicated by a dotted line in the figure indicates an actually measured value, and a curve indicated by a solid line indicates a calculation result using Expression (16). In both of the graphs indicated by the solid line and the dotted line, the S11 parameter rises and falls in the vicinity of substantially 0 dB, and it can be said that the amplitudes of both substantially coincide with each other.

FIG. 9 is a graph illustrating an actually measured value of a phase of the S11 parameter and a phase calculated by using the above Expression (16). A curve indicated by a dotted line in the figure indicates an actually measured value, and a curve indicated by a solid line indicates a phase calculated by using Expression (16). In both of the graphs indicated by the solid line and the dotted line, the S11 parameter is approximately −180°, and it can be said that the phases of both substantially coincide with each other. That is, it is understood that the S11 parameter of the target object P0 can be calculated with high accuracy by adopting the method of the present embodiment.

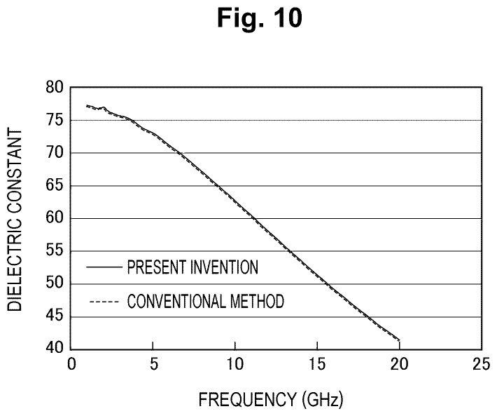

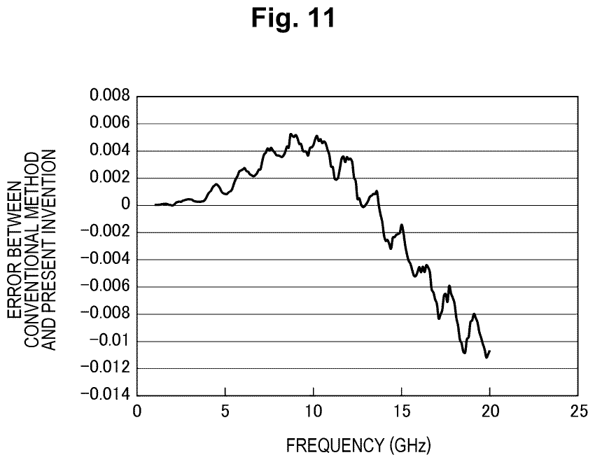

FIGS. 10 and 11 are graphs illustrating measurement results of a dielectric constant according to the present embodiment. FIG. 10 is a graph for comparing a result (indicated by a solid line) obtained by measuring a reflection coefficient by using air and water as calibration standards, calculating an S11 parameter of short circuit calibration by using Expression (16), and calculating a dielectric constant of an aqueous glucose solution (5 g/dL) as a target object with a result (indicated by a dotted line) obtained by calculating the dielectric constant by using Expression (6) according to the conventional method. The solid line and the dotted line in FIG. 10 favorably coincide with each other.

FIG. 11 is a graph illustrating an error between the dotted line and the solid line illustrated in FIG. 10. As understood from FIG. 11, it can be said that a dielectric constant can be measured within an absolute error of about 0.01 after the short circuit calibration is omitted. By adopting the method of the present embodiment, it is found that a dielectric constant of a target object is measured by performing the dielectric spectroscopic measurement with high accuracy even in a case where a measurement jig is not used.

As described above, the dielectric constant measurement method according to the present embodiment is a dielectric constant measurement method of measuring a dielectric constant of a target object by using the dielectric spectroscopy sensor 1, the method including: a step of acquiring an admittance of a first calibration standard of which a dielectric constant is known; a step of measuring the first reflection coefficient of the first calibration standard; a step of calculating an open reflection coefficient in an ideal open state of the dielectric spectroscopy sensor on the basis of the first reflection coefficient and the admittance of the first calibration standard when the first calibration standard is installed on a measurement end surface of the dielectric spectroscopy sensor; a step of calculating a reflection coefficient of another calibration standard on the basis of the open reflection coefficient and the admittance of another calibration standard other than the first calibration standard; a step of measuring a reflection coefficient of the target object; a step of calculating a dielectric constant of the target object on the basis of the first reflection coefficient, the reflection coefficient of another calibration standard, the reflection coefficient of the target object, the admittance of the first calibration standard, and the admittance of the another calibration standard.

In the dielectric constant measurement method according to the present embodiment, the reflection coefficient (S11 parameter) is measured by using at least one calibration standard, and the dielectric constant εs of the target object P0 can be calculated on the basis of the measurement result. Therefore, it is possible to reduce trouble such as installing a calibration standard on the measurement end surface N1 of the dielectric spectroscopy sensor 1, and it is possible to measure a dielectric constant with high accuracy without requiring an operator's advanced technical skill and without requiring a measurement jig.

Since a device such as a temperature sensor is unnecessary at the time of measuring a dielectric constant, a device scale can be reduced and the dielectric constant can be easily measured.

By using air as the calibration standard P1, it is possible to reduce the trouble of bringing the calibration standard P1 into contact with the measurement end surface N1 and to simplify a dielectric constant measurement process. Since the air has high measurement: reproducibility, the air is less affected by the surrounding environment at the time of measurement, and a dielectric constant can be measured with high accuracy.

By using a metal as the calibration standard P1, a dielectric constant calculation process can be executed by changing the above Expression (17) to Expression (16). Therefore, a calculation load on the measurement device 2 can be reduced.

### Description of Second Embodiment

Next, a second embodiment will be described. A dielectric constant measurement system according to the second embodiment has the same configuration as the dielectric constant measurement system 100 illustrated in FIG. 1. The second embodiment is different from the first embodiment described above only in a processing procedure. Therefore, a description of the configuration of the dielectric constant measurement system according to the second embodiment will be omitted.

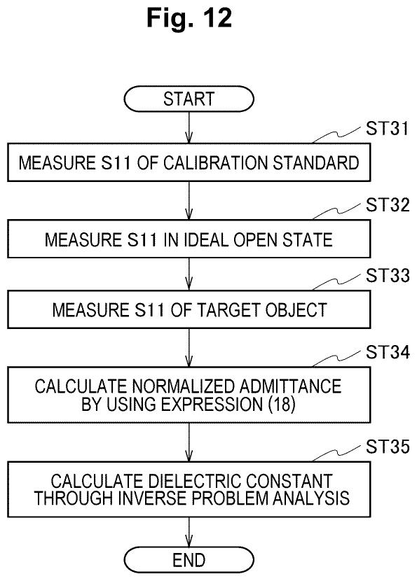

Hereinafter, a processing procedure of the dielectric constant measurement method according to the second embodiment will be described with reference to a flowchart of FIG. 12. FIG. 12 is a flowchart: illustrating a processing procedure of the dielectric constant measurement method according to the second embodiment.

First, a normalized admittance of the calibration standard P1 is acquired. If an admittance of the calibration standard is known, the normalized admittance is obtained d on the basis of this admittance. Alternatively, the normalized admittance is calculated by substituting the dielectric constant of the calibration standard P1 into the admittance calculation expression shown in the above Expression (9). That is, the admittance of the first calibration standard of which a dielectric constant is known is acquired.

In step ST31, the measurement unit 21 of the measurement device 2 measures an S11 parameter (S11_load; first reflection coefficient) of the calibration standard P1. That is, the measurement unit 21 measures the first reflection coefficient of the first calibration standard. The calibration standard P1 is, for example, air. Since the air does not require a measurement jig and a temperature sensor and has high reproducibility, it does not require much trouble of measuring the S11 parameter. Note that the calibration standard P1 is not limited to air, and other substances may be used.

On the basis of the admittance of the calibration standard P1 (first calibration standard) and the dielectric constant of the calibration standard P1, the above Expression (9) (first admittance calculation expression), which is a calculation expression for calculating an admittance from the dielectric constant, can be generated.

In step ST32, the calculation unit 22 calculates the normalized admittance Yprobe (εs) in the ideal open state according to above Expression (9). The calculation unit 22 substitutes the calculated normalized admittance Yprobe(εs) into the above Expression (17), and further substitutes “S11_load” measured in step ST31 to calculate the S11 parameter (S11_Idealopen) in the ideal open state.

That is, the normalized admittance of the calibration standard P1 and the first reflection coefficient are substituted into the reflection coefficient calculation expression (17) indicating a relationship between the first reflection coefficient (S11_load), the normalized admittance of the calibration standard P1, and the open reflection coefficient (S11_Idealopen) in the ideal open state of the dielectric spectroscopy sensor 1 when the calibration standard P1 (first calibration standard) is installed on the measurement end surface N1 of the dielectric spectroscopy sensor 1 to calculate the open reflection coefficient (S11 parameter).

In a case where a metal is used as the calibration standard P1, the above Expression (16) may be used instead of Expression (17). That is, when the calibration standard is a metal (short circuit), Expression (16) is established, and thus, even if the normalized admittance Yprobe(εs) is not calculated, S11_Idealopen can be calculated by multiplying S11_short by “−1”.

In step ST33, the measurement unit 21 measures an S11 parameter of the target object P0. That is, a reflection coefficient of the target object P0 is measured. Here, when the above Expression (17) is solved for Yprobe(εs), the following Expression (18) is obtained.

$$\begin{matrix}[ Math . 18 ] & \\ {Y}_{probe} ( {ε}_{s} ) = \frac{{S}_{11 Idealopen} - S {11}_{load}}{{S}_{11 Idealopen} + S {11}_{load}} & ( 18 )\end{matrix}$$

That is, it is possible to generate Expression (18) (second admittance calculation expression) that is a calculation expression for calculating the admittance of the target object P0 on the basis of the reflection coefficient (first reflection coefficient) of the calibration standard P1 and the open reflection coefficient of the dielectric spectroscopy sensor 1 in the ideal open state.

In step ST34, the calculation unit 22 calculates the normalized admittance Yprobe(εs) according to the above Expression (18) by using S11_Idealopen in the ideal open state and the S11 parameter of the target object P0.

Here, since the normalized admittances Yprobe(εs) are calculated according to both the above Expression (9) and the above Expression (18), the admittances are equal to each other. Therefore, the following Expression (19) is obtained.

$$\begin{matrix}[ Math . 19 ] & \\ \frac{{jk}_{0} {ε}_{s}}{\sqrt{{ε}_{c}} log ( \frac{b}{a} )} {\int }_{0}^{∞} \frac{{[ {J}_{0} ( ζ a ) - {J}_{0} ( ζ b ) ]}^{2}}{γ ( {ε}_{s} ) ζ} d ζ = \frac{{S}_{11 Idealopen} - S {11}_{load}}{{S}_{11 Idealopen} + S {11}_{load}} & ( 19 )\end{matrix}$$

In step ST35, the calculation unit 22 calculates the dielectric constant εs of the target object P0 by obtaining the dielectric constant εs satisfying the above Expression (19) through inverse problem analysis. That is, the dielectric constant εs of the target object P0 is calculated on the basis of the fact that the admittance calculated by using the first admittance calculation expression is equal to the admittance calculated by using the second admittance calculation expression.

As described above, also in the dielectric constant measurement method according to the second embodiment, similarly to the first embodiment described above, the reflection coefficient (S11 parameter) is measured by using at least one calibration standard, and the dielectric constant εs of the target object P0 can be calculated on the basis of the measurement result. Therefore, it is possible to reduce the trouble such as installing a calibration standard on the measurement end surface N1 of the dielectric spectroscopy sensor 1, and it is possible to measure a dielectric constant with high accuracy without requiring an operator's advanced technical skill.

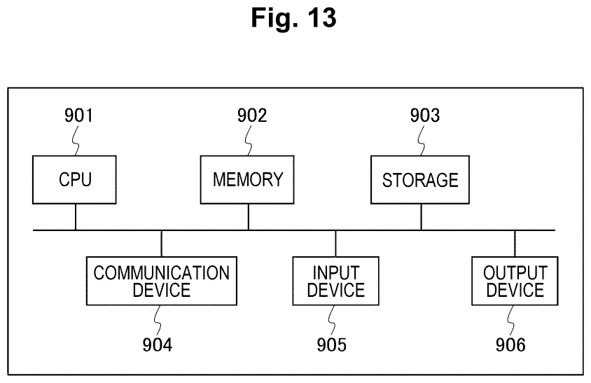

As illustrated in FIG. 13, for example, a general-purpose computer system including a central processing unit (CPU; processor) 901, a memory 902, a storage 903 (a hard disk drive (HDD) or a solid state drive (SSD)), a communication device 904, an input device 905, and an output device 906 may be used as the dielectric constant measurement system 100 of the present embodiment described above. The memory 902 and the storage 903 are storage devices. In this computer system, each function of the dielectric constant measurement system 100 is realized by the CPU 901 executing a predetermined program loaded on the memory 902.

Note that the measurement device 2 may be implemented by one computer or may be implemented by a plurality of computers. The measurement device 2 may be a virtual machine installed on a computer.

Note that the program for the measurement device 2 may be stored in a computer-readable recording medium such as an HDD, an SSD, a Universal Serial Bus (USB) memory, a compact disc (CD), or a digital versatile disc (DVD), or may be distributed via a network.

The present invention is not limited to the above embodiments, and various modifications can be made within the scope of the concept of the present invention.

### REFERENCE SIGNS LIST

1 Dielectric spectroscopy sensor
2 Measurement device
3 Transmission line
10 Coaxial probe
11 Inner conductor
12 Outer conductor
13 Insulator
14 Connector
15 Fringe
21 Measurement unit
22 Calculation unit
23 Storage unit
100 Dielectric constant measurement system
N1 Measurement end surface
N2 Calibration end surface

1. A dielectric constant measurement method of measuring a dielectric constant of a target object by using a dielectric spectroscopy sensor, the dielectric constant measurement method comprising:
a step of acquiring an admittance of a first calibration standard of which a dielectric constant is known;
a step of measuring a first reflection coefficient of the first calibration standard;
a step of calculating an open reflection coefficient in an ideal open state of the dielectric spectroscopy sensor on the basis of the first reflection coefficient and the admittance of the first calibration standard when the first calibration standard is installed on a measurement end surface of the dielectric spectroscopy sensor;
a step of calculating a reflection coefficient of another calibration standard other than the first calibration standard on the basis of the open reflection coefficient and an admittance of the another calibration standard;
a step of measuring a reflection coefficient of the target object; and
a step of calculating the dielectric constant of the target object on the basis of the first reflection coefficient, the reflection coefficient of the another calibration standard, the reflection coefficient of the target object, the admittance of the first calibration standard, and the admittance of the another calibration standard.

2. The dielectric constant measurement method according to claim 1, wherein the another calibration standard includes a metal.

3. The dielectric constant measurement method according to claim 1, wherein the first calibration standard includes water.

4. A dielectric constant measurement method of measuring a dielectric constant of a target object by using a dielectric spectroscopy sensor, the dielectric constant measurement method comprising:
a step of acquiring an admittance of a first calibration standard of which a dielectric constant is known;
a step of measuring a first reflection coefficient of the first calibration standard;
a step of generating a first admittance calculation expression for calculating an admittance from a dielectric constant on the basis of the admittance of the first calibration standard and the dielectric constant;
a step of generating a second admittance calculation expression for calculating an admittance of the target object on the basis of the first reflection coefficient and an open reflection coefficient in an ideal open state of the dielectric spectroscopy sensor; and
a step of calculating the dielectric constant of the target object on the basis of a fact that an admittance calculated by using the first admittance calculation expression is equal to an admittance calculated by using the second admittance calculation expression.

5. The dielectric constant measurement method according to claim 4, wherein the first calibration standard includes water.

6. A dielectric constant measurement system comprising:
a dielectric spectroscopy sensor having a coaxial probe and a measurement end surface formed at the coaxial probe; and
a measurement device connected to the dielectric spectroscopy sensor via a transmission line having the same characteristic impedance as a characteristic impedance of the coaxial probe, wherein
the measurement device includes
a measurement unit that applies a predetermined voltage to the dielectric spectroscopy sensor and measures a reflection coefficient of a measurement object on the basis of a reflection signal of the predetermined voltage, and
a calculation unit that
calculates an open reflection coefficient in an ideal open state of the dielectric spectroscopy sensor on the basis of a first reflection coefficient of a first calibration standard and an admittance of the first calibration standard when the first calibration standard is installed on a measurement end surface of the dielectric spectroscopy sensor,
calculates a reflection coefficient of another calibration standard other than the first calibration standard on the basis of the open reflection coefficient and an admittance of the another calibration standard, and
calculates a dielectric constant of a target object on the basis of the first reflection coefficient, the reflection coefficient of the another calibration standard, a reflection coefficient of the target object measured by the measurement unit, the admittance of the first calibration standard, and the admittance of the another calibration standard.

7. A dielectric constant measurement program for causing a computer to execute the dielectric constant measurement method according to claim 1.

8. The dielectric constant measurement method according to claim 2, wherein the first calibration standard includes water.

9. A dielectric constant measurement program for causing a computer to execute the dielectric constant measurement method according to claim 2.

10. A dielectric constant measurement program for causing a computer to execute the dielectric constant measurement method according to claim 3.

11. A dielectric constant measurement program for causing a computer to execute the dielectric constant measurement method according to claim 4.

12. A dielectric constant measurement program for causing a computer to execute the dielectric constant measurement method according to claim 5.
